(19) United States
(12) Patent Application Publication
(10) Pub. No.: US 2014/0218141 A1
(43) Pub. Date: Aug. 7, 2014

(54) SPLIT ARMATURE RELAY

(71) Applicants: Samuel Billot, Munchen (DE); Mathias Fein, Besigheim-Ottmarsheim (DE); Martin Mezger, Stuttgart (DE)

(72) Inventors: Samuel Billot, Munchen (DE); Mathias Fein, Besigheim-Ottmarsheim (DE); Martin Mezger, Stuttgart (DE)

(73) Assignee: ROBERT BOSCH GMBH, Stuttgart (DE)

(21) Appl. No.: 14/130,312

(22) PCT Filed: Jun. 28, 2012
(86) PCT No.: PCT/EP2012/062569

§ 371 Date: Apr. 9, 2014

(30) Foreign Application Priority Data
Jun. 30, 2011 (DE) 10 2011 078 426.8

(51) Int. Cl. H01H 50/30

(52) U.S. Cl. CPC H01H 50/30; H01H 2221/062
USPC 335/203

(57) ABSTRACT

The invention relates to a toe-in actuator (16), in particular a relay for an electric starter device (10) for internal combustion engines, said toe-in actuator providing a movable armature (168) and an armature return element (171) in a housing (156). The armature (168) is split into at least two armature parts (216, 218), and at least one damping element (220, 220a, 220b, 220c, 220d) is provided between the at least two armature parts (216, 218).

### BACKGROUND OF THE INVENTION

The invention relates to a toe-in actuator, in particular a relay for an electric starter device for internal combustion engines.

Starters or motor starters for internal combustion engines such as diesel engines or spark ignition engines typically comprise a starter motor, which, during the start-up process, drives the ring gear of the internal combustion engine via a pinion. A starter is nowadays generally controlled via an engagement relay, which, when supplied with current, produces a current flow to the starter motor and at the same time engages the pinion via a displacement type of armature.

DE 101 24 506 A1 relates to a starter for a motor vehicle. The starter of a motor vehicle with an internal combustion engine contains, inter alia, a pole casing containing the starter motor and an engagement relay containing a solenoid switch arranged parallel to said pole casing. A starter of this type is exposed to strong ambient influences, contaminations and moisture, in particular in the case of commercial vehicles, off-road vehicles, and military vehicles. Influences of this type are not critical for the starter electric motor in the pole casing. In the engagement relay, influences of this type are by contrast very critical, in particular because they may influence the switch arranged in the engagement relay for the starter current and the air gap between the solenoid armature and the surrounding stator part. It is therefore known to provide a seal with respect to ambient influences of this type on the starter casing. The seal is formed by a rubber membrane connected to the casing walls within the transition region between pole casing and the engagement relay. The rubber membrane is preferably arranged at the rotation point of the engagement lever and is injection-molded onto the holder of the engagement lever or onto the engagement lever itself.

DE 195 49 179 A1 describes an engagement relay for a starter device. The starter device comprises at least two contact pins, which are bridged by a contact bridge in the switched-on state. This is attached to a movable switch shaft. The contact bridge has at least two defined contact regions which are associated with a contact pin and which are provided on flexible spring arms in their longitudinal extent and transverse to their longitudinal extent. The contact regions are arranged on contact lugs, which are produced by bending, stamping or deep drawing the spring arms in the direction of the contact pins. The spring arms can be produced by at least one recess running in the direction of a virtual line arranged perpendicular to the center axis of the switch shaft.

In the course of new developments with respect to fuel saving and comfort, high demands are nowadays placed on starters. For example, within the scope of start-stop modes, the demand on the service life of a starter has thus risen from approximately 40,000 start-up processes to more than half a million. Furthermore, in particular in the case of passenger vehicles in the high-price sector, the noises produced by the starter, whether during the initial start-up or within the scope of start-stop modes, are found to be bothersome. The impact of the armature on the armature return element in the relay is in particular responsible for this development of noise.

### SUMMARY OF THE INVENTION

In accordance with the invention, a toe-in actuator, in particular a relay for an electric starter device for internal combustion engines, with a casing is proposed, in which a movable armature and an armature return element are received, wherein the armature is split into at least two armature parts and at least one damping element is provided between the at least two armature parts.

The solution proposed in accordance with the invention of a split armature makes it possible to decouple parts of the armature mass by means of damping elements between the at least two armature parts. In this way, the masses of the armature parts contacting an armature return element can be controlled in order to thus considerably reduce the development of noise when the armature contacts the armature return element. The level of noise generated by a starter, in particular with actuation of the toe-in actuator according to the invention, is thus significantly reduced.

In accordance with an embodiment, the splitting of the armature into the at least two armature parts runs in the axial direction. With an armature split in the axial direction, the at least two armature parts are consequently arranged coaxially. This coaxial arrangement of the at least two armature parts has the advantage that the effects on the magnetic flux in the armature can thus be minimized. Furthermore, the at least two armature parts can be manufactured from the same or different ferromagnetic materials. Here, rust-resistant materials could be used for example so that the infiltration of rust between the coaxial armature parts can be avoided and the armature parts can move freely axially over the entire service life.

In accordance with an advantageous embodiment, the splitting of the armature is designed such that at least one armature part of the at least two armature parts has a mass smaller than the further armature parts. Within the scope of the present invention, it is possible to therefore utilize the fact that armature parts that have a smaller mass produce less noise upon contact with the armature return element. Furthermore, the geometry of the at least one armature part that has the smaller mass compared to the further armature parts can be selected such that, during the impact of the armature, it is this armature part that is first to contact the armature return element, and the movement of the further armature parts with greater mass is damped by the at least one damping element. The total mass of the armature can thus be prevented from contacting the armature return element simultaneously. The toe-in actuator proposed in accordance with the invention therefore allows a decoupling of the armature masses and thus reduces the development of noise.

In a further embodiment, the at least one armature part that has a mass smaller than the further armature parts can be formed on the inner periphery of the armature, on the outer periphery of the armature, or within the armature between the inner and outer periphery of the armature. The armature can thus be axially split in radially different regions of the armature, which enables a high versatility with regard to the design of the toe-in actuator according to the invention. Depending on the embodiment of the surface geometry, that is to say the embodiment of the end faces of the armature and of the armature return element contacting one another, different elements of the armature can thus be decoupled. On the one hand the mass of the at least two axially decoupled armature parts and on the other hand the position thereof on the surface geometry of the armature contacting the armature return element can therefore be selected such that an optimal minimization of noise results. Furthermore, in the case of the embodiment on the inner periphery of the armature, the guidance of the small armature on further armature parts can be optimized in terms of the tolerance chain, coaxiality and the length of the dividing line. In an embodiment on the outer periphery of the armature, a small tolerance chain can be achieved for the positioning of the noise damping.

In accordance with a further embodiment of the toe-in actuator according to the invention, at least one armature part has a mass greater than the further armature parts, wherein the armature part with the greater mass preferably forms an end stop on the end face of the armature. The axial movement of the armature may, with a multi-part embodiment of the armature, result in a number of impacts on the armature return element. The end stop of the armature part that has a mass greater than the further armature parts then prevents an overstressing of the damping element.

In accordance with a further embodiment, the at least one damping element is provided as an axial damping element between at least two contact surfaces of the at least two armature parts. Here, the damping element in particular damps the axial movement between the at least two armature parts. This thus leads to an impact of the at least two armature parts that is damped in a controlled manner.

The at least one damping element may comprise a resilient damping material, which is received between the at least two armature parts by being vulcanized on, adhesively bonding on or injection-molded on and/or is received in a form-fitting manner. In this case, “form-fitting” denotes any type of connection in which a fixed connection is produced by the engagement in one another of at least two connection partners. A form-fitting connection can thus be produced for example by plastic deformation or calking Rings or washers made of resilient material can also be used as damping elements between the at least two armature parts and are received on the periphery of the armature or at least one armature part. Furthermore, the at least one damping element may comprise a resilient damping material, such as polyamides (PA), thermoplastics, thermoplastic elastomers (TPE), elastomers or rubbers. These damping materials preferably have a Shore hardness between 10 and 70. Here, the Shore hardness is a parameter for the hardness of soft materials such as elastomers and plastics. It ranges over a scale from 0 to 100, wherein 100 corresponds to the greatest hardness.

In accordance with a further embodiment, the end faces of the at least two armature parts, in a part of the armature pointing away from the armature return element, have axial projections that engage in one another. Here, at least one damping element may be provided between contact surfaces of the projections of the at least two armature parts. This embodiment of the toe-in actuator proposed in accordance with the invention makes it possible, besides the minimization of noise as a result of the splitting of the armature with damping elements, to also increase the magnetic flux in the at least two armature parts.

### BRIEF DESCRIPTION OF THE DRAWINGS

The invention will be described in greater detail hereinafter with reference to the drawings, in which:

FIG. 1 shows a longitudinal section of a starter device,

FIG. 2 shows a variant of the toe-in actuator according to the invention with split armature in outer geometry,

FIG. 3 shows a variant of the toe-in actuator according to the invention with split armature in the inner geometry,

FIG. 4 shows a variant of the toe-in actuator according to the invention with split armature in intermediate geometry,

FIG. 5 shows a variant of the toe-in actuator according to the invention with split armature, wherein the second armature part surrounds the first armature part and the damping element is vulcanized in,

FIG. 6 shows a variant of the toe-in actuator according to the invention with split armature, wherein the second armature part surrounds the first armature part and the damping element is fixed by a securing ring or by calking,

FIG. 7 shows a variant of the toe-in actuator according to the invention in inner geometry, wherein the contour of the end stop is illustrated in bold,

FIGS. 8a-8e show variants of the toe-in actuator according to the invention in outer geometry, wherein different geometries with regard to the end stop are illustrated,

FIG. 9 shows a variant of the toe-in actuator according to the invention with projections engaging in one another at the contact surface between the armature parts.

### DETAILED DESCRIPTION

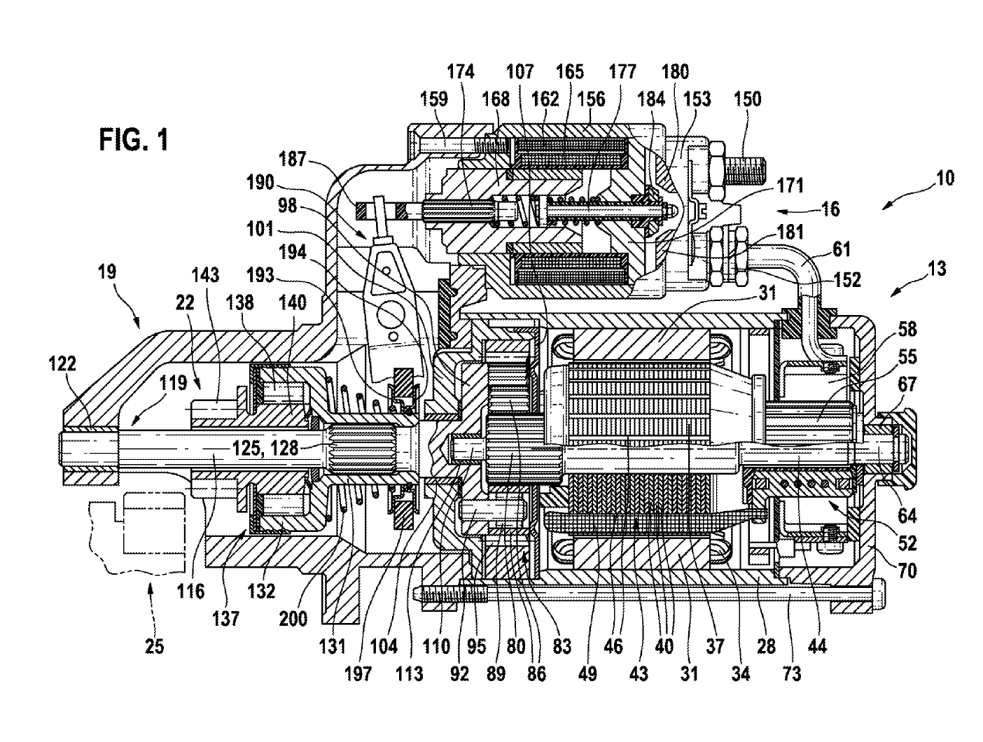

FIG. 1 shows a starter 10 in a longitudinal section, wherein this starter for example comprises a toe-in actuator 16 (for example relay, starter relay), a starter motor 13 and a torque-transmission line with epicyclic gear train 83 and pinion 22. The starter motor 13 and the electric toe-in actuator 16 are secured to a common drive shield 19. The starter motor 13 is used functionally to drive a starter pinion 22 when engaged in the ring gear 25 of the internal combustion engine (not illustrated in FIG. 1).

The starter motor 13, as a casing, has a pole tube 28, which on its inner periphery carries pole shoes 31, around each of which an excitation winding 34 is wound. The pole shoes 31 in turn surround an armature 37, which has an armature bundle 43 formed from bars 40 and an armature winding 49 arranged in grooves 46. The armature bundle 43 is pressed onto a drive shaft 44. A commutator 52 is also attached to the end of the drive shaft 44 remote from the starter pinion 22 and is formed inter alia from individual commutator bars 55. The commutator bars 55 are electrically connected in a known manner to the armature winding 49 in such a way that, as current is supplied to the commutator bars 55 through carbon brushes 58, a rotary movement of the armature 37 within the pole tube 28 is produced. A current feed 61 arranged between the electric drive 16 and the starter motor 13, in the switched-on state, supplies both the carbon brushes 58 and the excitation winding 34 with current. The drive shaft 44 is supported on the commutator side with a shaft journal 64 in a sliding bearing 67, which is in turn held fixedly in a commutator bearing cover 70. The commutator bearing cover 70 is in turn secured in the drive end shield 19 by means of tension rods 73, which are distributed over the periphery of the pole tube 28 (screws, for example two, three or four). Here, it supports the pole tube 28 on the drive end shield 19 and the commutator bearing cover 70 on the pole tube 28.

Viewed in the drive direction, the armature 37 is adjoined by a sun gear 80, which is part of an epicyclic gear train 83, in particular a planetary gear train. The sun gear 80 is surrounded by a plurality of planetary wheels 86, normally by three planetary wheels 86, which are supported by means of rolling bearings 89 on journals 92. The planetary wheels 86 roll in an internal gear 95, which is mounted externally in the pole tube 28. In the direction toward the output side, the planetary wheels 86 are adjoined by a planetary carrier 98, in which the journals 92 are received. The planetary carrier 98 is in turn mounted in an intermediate bearing 101 and a sliding bearing 104 arranged therein. The intermediate bearing 101 is formed in a pot-shaped manner in such a way that both the planetary carrier 98 and the planetary wheels 86 are received therein. Furthermore, the internal gear 95, which is ultimately closed by a cover 107 with respect to the armature 37, is arranged in the pot-shaped intermediate bearing 101. The intermediate bearing 101 is also supported via its outer periphery on the inner face of the pole tube 28. The armature 37, on the end of the drive shaft 44 remote from the commutator 52, has a further shaft journal 110, which is likewise received in a sliding bearing 113. The sliding bearing 113 is in turn received in a central bore in the planetary carrier 98. The planetary carrier 98 is connected in one piece to the output shaft 116. The output shaft 116 is supported via its end 119 remote from the intermediate bearing 101 in a further bearing 122, which is secured in the drive end shield 19.

The output shaft 116 is divided into various portions: the portion that is arranged in the sliding bearing 104 of the intermediate bearing 101 is thus followed by a portion having a spur toothing 125 (internal toothing), which is part of a shaft-hub connection 128. This shaft-hub connection 128 in this case enables a driver 131 to slide axially in a straight line. The driver 131 is a sleeve-shaped extension, which is connected in one piece to a pot-shaped outer ring 132 of the freewheel 137. This freewheel 137 (non-return device) further consists of the inner ring 140, which is arranged radially inside the outer ring 132. Clamping members 138 are located between the inner ring 140 and the outer ring 132. The clamping members 138, in cooperation with the inner ring and the outer ring 132, 140, prevent a relative rotation between the outer ring 132 and the outer ring 140 in a second direction. In other words: the freewheel 137 enables a peripheral relative movement between the inner ring 140 and the outer ring 132 only in one direction. In this exemplary embodiment, the inner ring 140 is formed in one piece with the starter pinion 22 and the helical toothing 143 (outer helical toothing) thereof. The starter pinion 22 may alternatively also be formed as a spur-toothed pinion. Instead of electromagnetically excited pole shoes 31 with excitation winding 34, permanent-magnetically excited poles could also be used.

The electric toe-in actuator 16 or the armature 168 additionally also has the task of moving, by means of a tension element 187, a lever 190 arranged rotatably in the drive end shield 19. The lever 190 is conventionally formed as a forked lever and, by means of two “prongs” (not illustrated here in greater detail), surrounds two washers 193, 194 at their outer periphery in order to move a driving collar 197 clamped therebetween toward the freewheel 137 against the resistance of the spring 200 and to thus engage the starter pinion 22 in the ring gear 25.

The starter mechanism will be discussed in greater detail hereinafter. The electric toe-in actuator 16 has a pin 150, which is an electric contact and in the case of being installed in the vehicle is connected to the positive terminal of an electric starter battery, which is not illustrated in FIG. 1. The pin 150 is passed through a cover 153. A second pin 152 is a connection for the electric starter motor 13, which is supplied via the current feed 61 (thick stranded wire). The cover 153 closes a casing 156 made of steel, which is secured to the drive end shield 19 by means of a plurality of securing elements 159, which can be formed for example as screws. A thrust arrangement for exerting a tensile force onto the lever 190, formed as a forked lever, and a switching arrangement are arranged in the electric toe-in actuator 16. The thrust arrangement has a winding 162, and the switching arrangement has a further winding 165. The winding 162 of the thrust arrangement and the further winding 165 of the switching arrangement each produce, in the switched-on state, an electromagnetic field, which passes through various components. The shaft-hub connection 128 may also be equipped with an oblique toothing instead of with a spur toothing 125. Here, the combinations of a) the starter pinion 22 is helically toothed and the shaft-hub connection 128 has a spur toothing 125, b) the starter pinion 22 is helically toothed and the shaft-hub connection 128 has an oblique toothing, or c) the starter pinion 22 is spur-toothed and the shaft-hub connection 128 has an oblique toothing are possible.

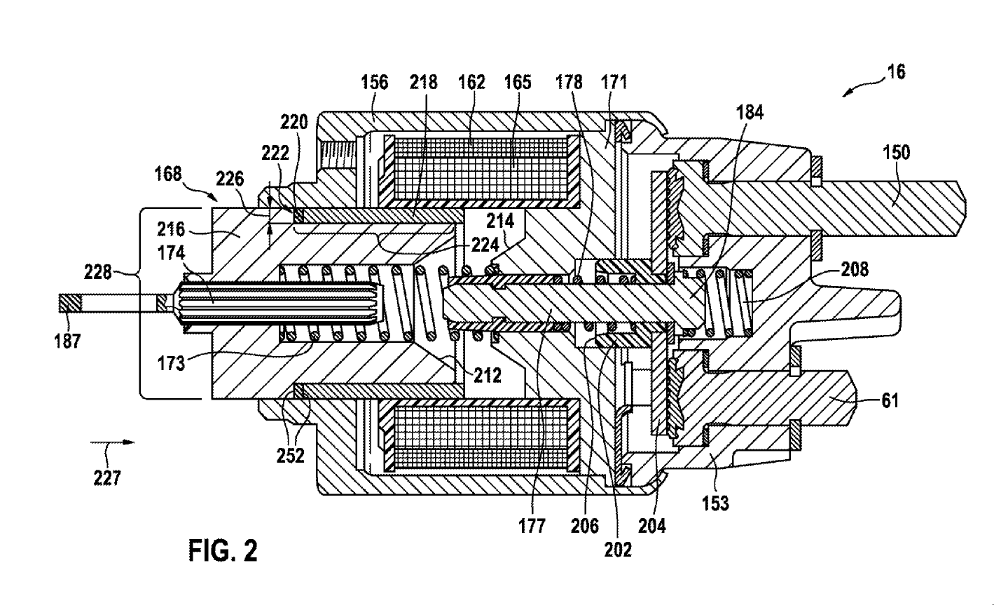

FIG. 2 shows an enlarged view of a toe-in actuator 16 according to FIG. 1, which in particular is designed as a relay for actuation of an electric starter device for internal combustion engines. This toe-in actuator 16 comprises a casing 156, in which a linearly movable armature 168 is provided. Furthermore, a pin 174 acted on by a spring 173 is provided in the movable armature and is connected to the lever 190 (not illustrated in FIG. 2).

As current is supplied to the pull-in winding 162 or the hold-in winding 165, the armature 168 experiences an axial force in the pull-in direction 227, which is characterized in FIG. 2 by the arrow 227. An armature return element 171 is arranged opposite the armature 168 actuatable in the pull-in direction 227 and is also referred to as a core plate. The end face of the movable armature 168 pointing toward the armature return element 171 is formed in a manner complementary to the end face of the armature return element 171 pointing toward the armature 168. In this case, the end face of the movable armature 168 pointing toward the armature return element 171 is denoted by reference sign 212. Furthermore, the complementary end face of the armature return element 171 pointing toward the armature 168 is denoted by reference sign 214.

If the armature 168 moves linearly toward the armature return element 171, the pin 174 thus causes the control pin 177 arranged in the armature return element 171 to experience a thrust in the pull-in direction. The control pin 177 is acted on by the spring 178 and is mounted in a guide bushing 202. The guide bushing 202 is in turn assigned a contact disc 204 and a switch shaft stop 206 in order to limit the path of the control pin 177. The contact bridge 184 is acted on by a contact spring 208 and, in the engaged state, produces a contact between the pin 150 and the current feed 61.

A variant of the toe-in actuator 16 proposed in accordance with the invention, which comprises an armature split into two armature parts 216, 218, is illustrated in FIG. 2. In the present embodiment, the armature 168 is split axially on the outer periphery. The first armature part 216 therefore, on the periphery of the lateral surface, has a cylindrical recess 224, which extends from the end face 212 to a length 222. A second armature part 218 is designed such that it can be received in the recess 224 in the first armature part 216. The first armature part 216 and the second armature part 218 are therefore arranged coaxially. Here, the second armature part 218 bears against the first armature part 216 along the lateral surface of the first armature part 216 as far as the end face over a length 222.

Furthermore, in the embodiment illustrated in FIG. 2, a damping element 220 is provided between the contact surfaces 252 of the first armature part 216 and of the second armature part 218. This damping element 220 is preferably introduced as a resilient washer in the space between the end face of the second armature part 218 pointing away from the armature return element 171 and the end face of the first armature part 216 pointing toward the armature return element 171. The damping element 220 is preferably vulcanized and thus produces a fixed connection between the first armature part 216 and the second armature part 218. The damping element 220 further produces a decoupling of the two armature parts 216, 218. This is because, as the armature 168 impacts on the armature return element 171, the second armature element 218 with lower mass than the first armature part 216 contacts first chronologically and the damping element 220 reduces the delay of the first armature part 216 in the event of collision of the armature 168 against the armature return element 171 such that the energy input onto the armature return element 171 is reduced. A minimization of noise as the split armature 168 impacts on the armature return element 171 can thus be achieved.

The width 226 of the second armature part 218 is preferably selected such that it does not exceed a quarter of the total width 228 of the armature 168. The mass of the second armature part 218 is thus smaller than the mass of the first armature part 216. Furthermore, the length 222 of the recess 224 in the embodiment illustrated in FIG. 2 corresponds at least to the length of the pull-in winding 162 or the hold-in winding 165. With such an embodiment of the axially split armature 168, the influence on the magnetic flux by the armature 168 can be minimized. This is because the magnetic field generated by the pull-in winding 162 or the hold-in winding 165 has magnetic field lines that run axially. The axial course of said lines is only influenced minimally by the axial splitting according to the invention of the armature 168. The length 222 or the length of the accompanying cylindrical recess 224 in another variant preferably corresponds at most to the distance from the corner point between an annular surface (not denoted in greater detail) adjacent to the coil carrier and the location on the casing 156 where said casing borders the armature part 218 and is closest to said corner point.

Within the scope of this coaxial embodiment of the axially split armature 168, the second armature part 218 may have a length that corresponds to the recess 224. By introducing the damping element 220, this means that the second armature part 218 at the end face 212 of the split armature 168 protrudes by the thickness of the damping element 220. The length of the second armature part 218 may however also be adapted such that the end faces of the first armature part 216 and of the second armature part 218 pointing toward the armature return element 171 form a continuous end face 212 pointing toward the armature return element 171, without projections. Furthermore, the armature part 218 may alternatively protrude slightly less than the axial length of the damping element 220 in the direction of movement. In addition, the damping element 220 has an outer diameter that is smaller than the inner diameter of a receiving element.

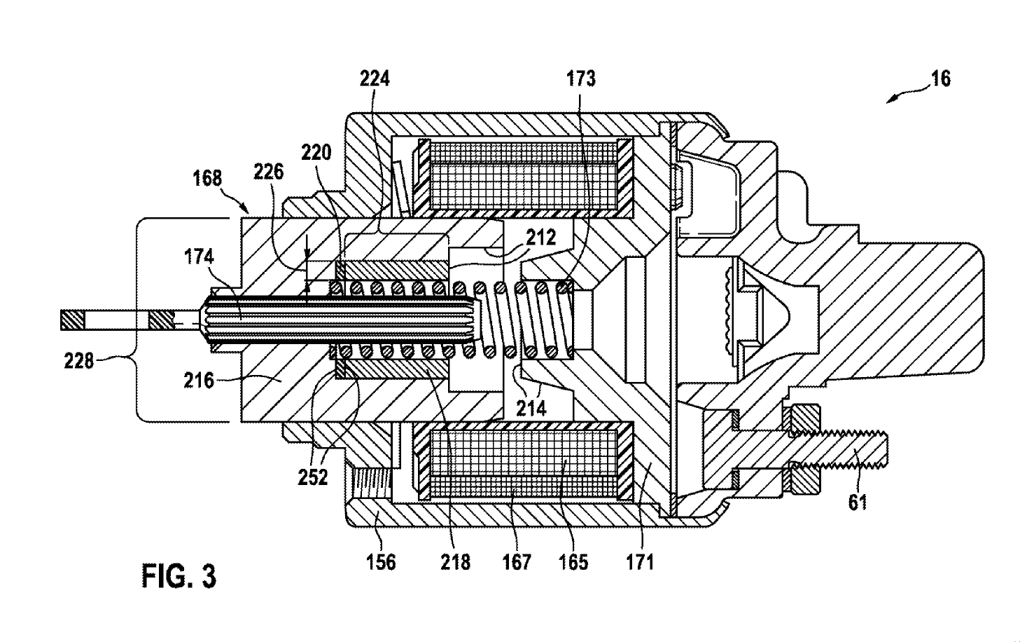

FIG. 3 shows a further variant of an armature 168 proposed in accordance with the invention. Here, the armature 168, in contrast to the outer geometry illustrated in FIG. 2, is split at the inner periphery of the armature 168. In this embodiment, the second armature part 218 is provided on the surface of the armature 168 pointing toward the pin 174, and the damping element 220 is introduced in the space between the contact surfaces 252 of the second armature part 218 and of the first armature part 216. Furthermore, the width of the second armature part 218 is preferably selected such that it does not exceed a quarter of the total width 228 of the armature 168. The mass of the second armature part 218 can thus be minimized compared to the first armature part 216. Due to the low radial extension of the second armature part 218 in this embodiment, the splitting of the armature 168 in the inner geometry illustrated here is also advantageous in relation to the outer geometry shown in FIG. 2. In this variant also, the length of the second armature part 216 corresponds at least to the length of the pull-in winding 162 or of the hold-in winding 165, such that the magnetic flux is not destroyed.

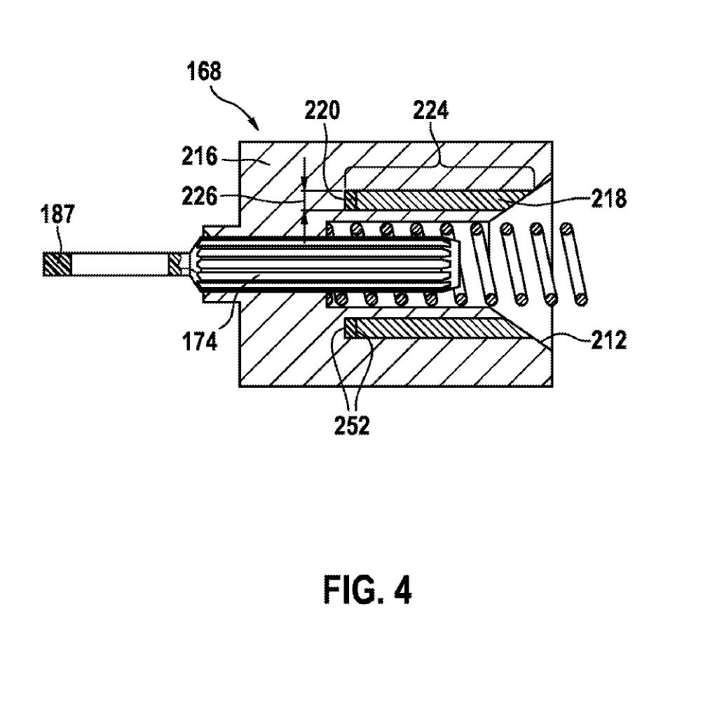

Besides the geometries illustrated in FIGS. 2 and 3, the armature 168 may also be split in an intermediate geometry. FIG. 4, in a schematic illustration of an armature 168, illustrates the splitting in intermediate geometry. In the present context, an intermediate geometry is understood to mean a splitting of the armature 168 that, as viewed radially, runs within the armature 168 between the inner and the outer periphery. The second armature part 218 is thus provided within the first armature part 216 in a width 226 along a length 224. Here too, the length of the axial splitting preferably corresponds at least to the length of the pull-in winding 162 or hold-in winding 165 (not illustrated in FIG. 4). The damping elements, as already described in conjunction with FIGS. 2 and 3, are also introduced between contact surfaces 252 of the first armature part 216 and of the second armature part 218.

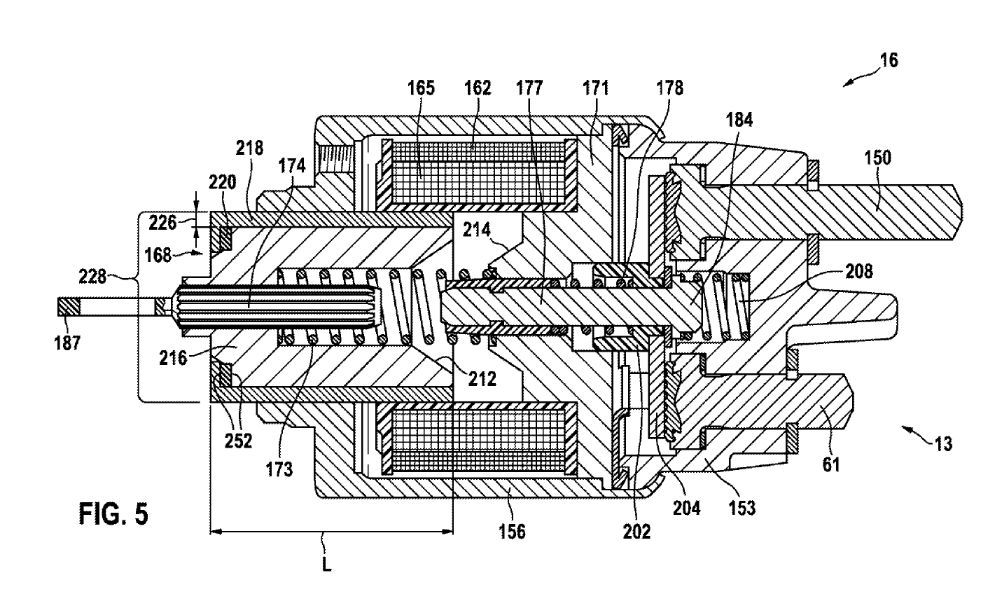

Alternatively to the embodiment illustrated in FIG. 2, the second armature part 218 in the outer geometry can also extend along the entire length L of the armature 168. This is shown in FIG. 5. Such an embodiment is possible both for the inner geometry illustrated in FIG. 3 and for the intermediate geometry illustrated in FIG. 4. In this embodiment also, the width 226 of the second armature part 218 should not exceed a quarter of the total width of the armature 168. Furthermore, the second armature part 218 is formed as a surrounding armature part in that it surrounds the first armature part 216 at the end face of the armature 168 pointing away from the armature return element 171. In this embodiment, the damping element 220 may advantageously be introduced as a vulcanized damping element 220 in the space between the contact surfaces 252, that is to say between the end face of the surrounding second armature part 218 pointing toward the armature return element 171 and the end face of the first armature part 216 pointing away from the armature return element 171. This enables a secure positioning and connection of the two armature parts 216, 218, since the surrounding second armature part 218 provides further securing in the axial direction.

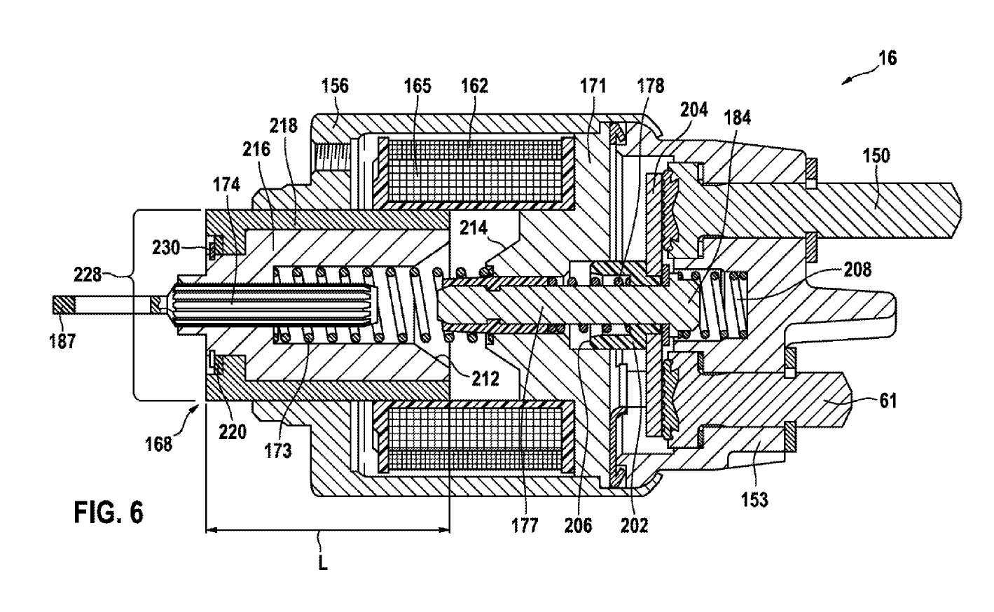

A further possibility of designing the split armature 168 with surrounding second armature part 218 lies in fixing the damping element 220 by means of a securing ring 230 or by calking This is illustrated by way of example in FIG. 6. In such an embodiment, the second armature part 218 preferably surrounds the first armature part 216. In the armature 168 illustrated in FIG. 6, the damping element 220 may also be provided outside the space between the end faces of the first armature part 216 and of the second armature part 216. Instead, the damping element 220 is formed on the rear lateral surface of the first armature part 216 and additionally produces a connection to the second armature part 218. The fixing of the damping element 220 is achieved by a securing ring 230 or by means of calking on the rear lateral surface of the first armature part 216. This allows a more cost-effective embodiment of the split armature 168 compared to vulcanized damping elements 220. However, further components are necessary in such a variant, thus making the assembly process more complex.

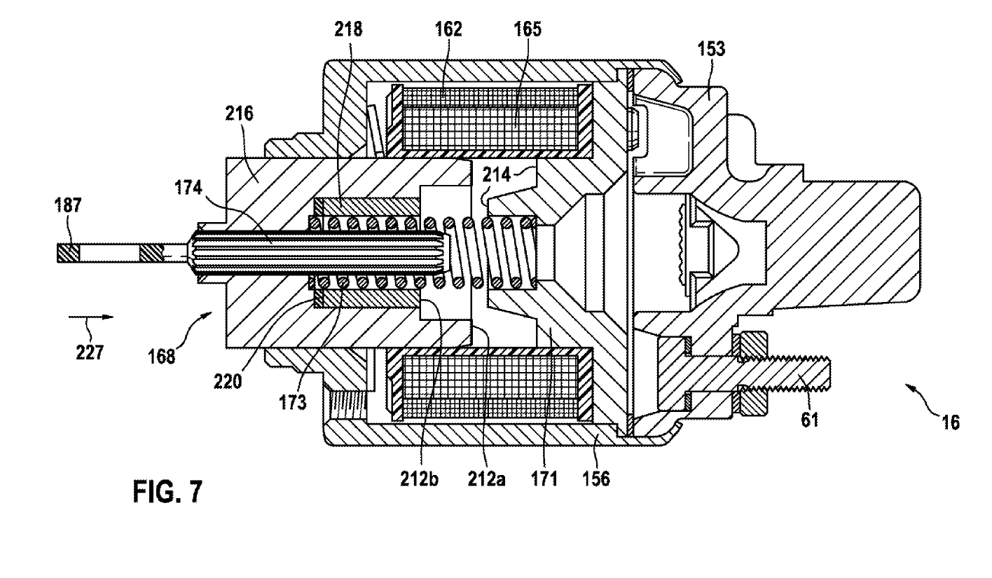

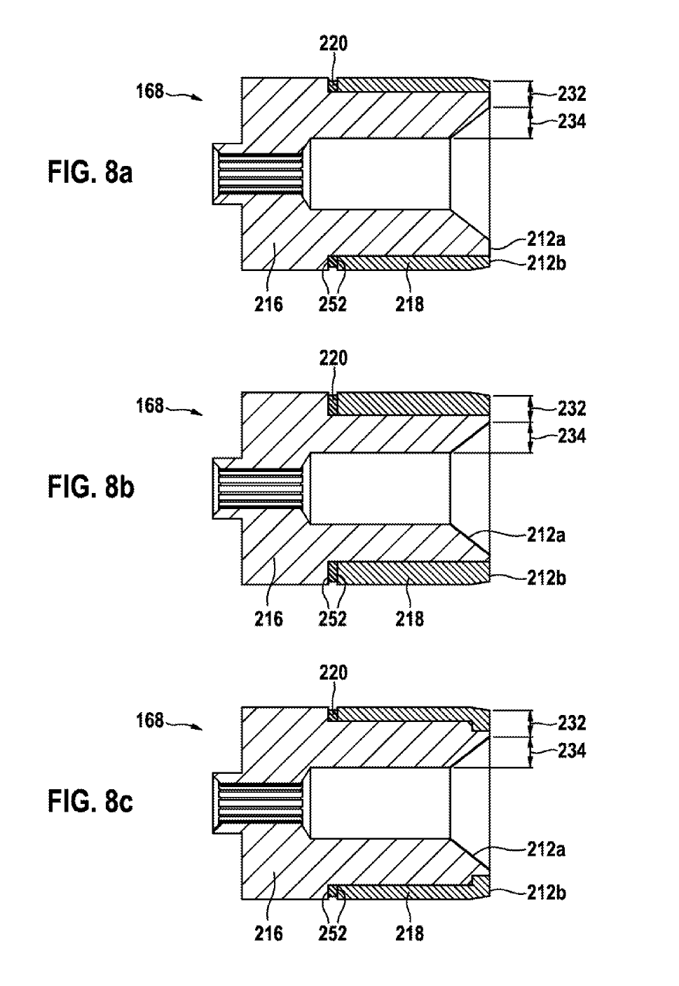

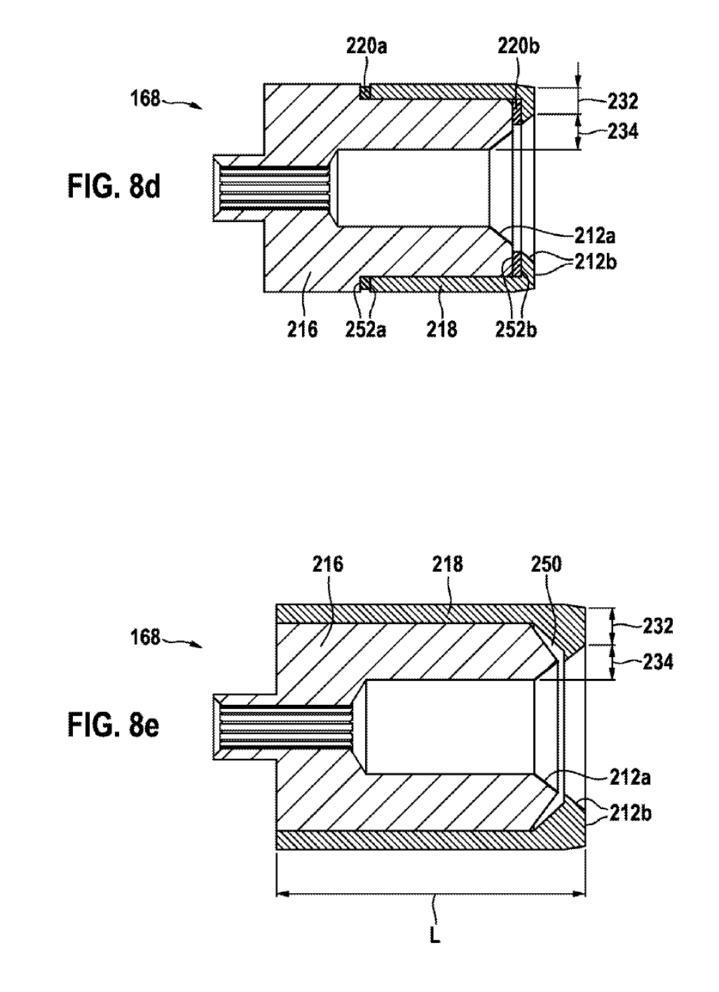

FIGS. 7 and 8a to 8e show different embodiments of a split armature 168, wherein in particular the contours of the impact surfaces 212 of the split armature 168 upon actuation of the toe-in actuator 16 are emphasized. Upon actuation of the toe-in actuator 16, the armature 168 according to the invention moves in the pull-in direction 227 and impacts on the armature return element 171, wherein the end faces 214 and 212 are formed in a manner complementary to one another. In the case of the toe-in actuator according to the invention with split armature 168, two impacts, which correspond to the impact of the first armature part 216 and to the impact of the second armature part 218, are produced due to the preferred splitting into two of the armature 168. This is only then the case however when the splitting of the armature 168 extends as far as the end face 212 of the armature 168. If the armature 168 according to the invention with split end face 212a, 212b impacts on the armature return element 171, the second armature part 218, which has a lower mass than the first armature part 216, will thus first contact the armature return element 171 via its end face 212b. The damping element 220 then damps the movement of the first armature part 216 with the greater mass. So as not to overload the damping element however, it is advantageous to provide an end stop 212a. This end stop 212a can be used by the additional mass dynamics and stops the movement of the first armature part 216 at extreme armature speed, for example at cold temperature and with fully charged battery.

The embodiment in FIG. 7 shows an armature 168 with the axial splitting in the inner geometry and corresponds substantially to the embodiment according to FIG. 3. The end stop 212a is emphasized again in FIG. 7.

An end stop 212a, as shown in FIGS. 8a to 8e, may also be provided with an axial splitting of the armature 168 in outer geometry. The explicit embodiment of the end stop 212a in both cases, that is to say with splitting of the armature 168 in outer geometry or inner geometry, is dependent on the shape of the complementary end faces 212, 214 of the armature 168 and of the armature return element 171.

FIGS. 8a to 8e show different variants for forming an end stop 212a for the geometry of the end face 212 shown in said figures. The geometry of the end face 212 is selected here such that the armature 168, as viewed in radial direction, has a straight outer portion 232 followed by a funnel-shaped inner portion 234. The armature 168 illustrated in FIG. 8a is split such that the end face 212 of the armature 168 in the straight outer portion 232 is split. The end stop 212a is therefore likewise located in this region. The armature part 218 is tubular and, for easier assembly, preferably has an externally peripheral chamfer (lead-in bevel). In FIG. 8b, the armature 168 is separated along the dividing line between the straight outer portion 232 and the funnel-shaped inner portion 234 in the radial direction into a second armature part 216 and first armature part 218. The end face 212 of the armature 168 consequently has an end stop 212a in the region of the funnel-shaped inner portion 234. Similarly, the end stop 212a in the embodiment of FIG. 8c is also provided in the region of the funnel-shaped inner portion 234. To this end, the second armature part 218, which, in the radial direction, has a smaller width than the straight outer portion 232, surrounds the first armature part 216 at the end face 212 of the armature. In the variants of FIGS. 8a to 8c, the damping element 220, as illustrated in FIG. 2, is introduced in the space between contact surfaces 252 of the first and of the second armature 216, 218.

It may also be advantageous however to provide further damping elements 220a, 220b. An example for this is shown in FIG. 8d. In this variant, the second armature part 218, which has a smaller width in the radial direction compared to the straight outer portion 232, completely surrounds the first armature part 216 at the end face 212 of the armature. Consequently, both the straight outer portion 232 and part of the funnel-shaped inner portion 234 form the end face 212b of the second armature part 218. The funnel-shaped inner portion 234 thus only partly forms the end stop 212a of the first armature part 216. In this embodiment, besides the damping element 220a between the contact surfaces 252a, a damping element 220b can advantageously be provided between the contact surfaces 252b of the first armature part 216 and of the second armature part 218 in the front part of the armature 168 pointing toward the armature return element 171. Here, the further damping prevents an overstressing of individual damping elements 220a, 220b in the rear or front part of the armature 168. Noises that originate from the contacting of the contact surfaces 252a, 252b can also be further reduced and the axial movement of the first armature part 216 further damped.

For the axial length of the armature parts 218, this is preferably defined as in exemplary embodiment 2.

FIG. 8e shows an embodiment in which resilient damping elements 220b, as in FIG. 8d, are provided in splitting of the armature 168, in particular in the region 250. Contact surfaces 250, separated from one another in the axial direction by a damping element 220b, between the first armature part 216 and the second armature part 218 are preferably provided in the front part of the armature 168 pointing toward the armature rear element 171. As is illustrated by way of example in FIG. 8e, the second armature part 218 to this end extends along the entire length L of the armature 168. The armature 168 illustrated in FIG. 8e is split such that the end face 212 of the armature 168 is split in the conically extending outer portion 234. The end stop 212a is therefore likewise located in this region. Here too, an elastomer for example is injected into the gap. As already described before, the mass, impact surface and the dividing line can be varied in this embodiment too. This embodiment is particularly advantageous in terms of the tolerance chain and the coaxiality when guiding the outer armature based on the relay and the further armature parts.

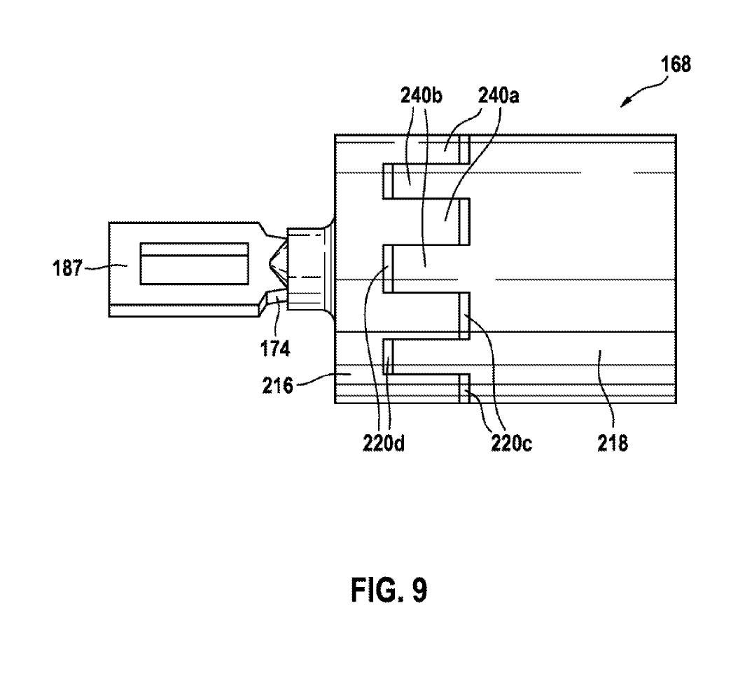

Lastly, it has proven to be advantageous for the magnetic flux when the armature parts 216, 218 of the armature 168 according to the invention engage in one another by means of projections 240a, 240b. This embodiment of a split armature 168 is shown by way of example in FIG. 9. There, the projections 240 of the first armature part 216 and the projections 240b of the second armature 218 are designed such that these engage in one another in a part of the armature pointing away from the armature return element. These projections 240a, 240b are formed in FIG. 9 in a right-angled manner. Other shapes for the projections 240a, 240b are also conceivable however. The projections 240a, 240b can thus in particular be formed in a circular, oval or trapezoidal manner. In such an embodiment, the damping elements 220c, 220d are provided both on the projections 240a and on the projections 240b. In this embodiment, the magnetic flux is maximized by the armature in a particularly advantageous manner.

The embodiments of the toe-in actuator 16 with split armature 168 according to the invention described above are to be understood as exemplary embodiments. Any combinations and variations of these embodiments are thus conceivable. Axial splittings of the armature that result in more than two armature parts and have advantageous effects on the minimization of noise in the event of impact of the armature 168 on the return element 171 without heavily disturbing the magnetic flux may also be provided.

1. A toe-in actuator (16), comprising a casing (156), in which a movable armature (168) and an armature return element (171) are received, characterized in that the armature (168) is split into at least two armature parts (216, 218) and at least one damping element (220, 220a, 220b, 220c, 220d) is provided between the at least two armature parts (216, 218).

2. The toe-in actuator (16) as claimed in claim 1, characterized in that the splitting of the armature (168) into the at least two armature parts (216, 218) runs in the axial direction.

3. The toe-in actuator (16) as claimed in claim 1, characterized in that splitting of the armature (168) is designed such that at least one armature part (216) of the at least two armature parts (216, 218) has a mass smaller than further armature parts (218).

4. The toe-in actuator (16) as claimed in claim 3, characterized in that the at least one armature part (216) that has the mass smaller than the further armature parts (216, 218), is formed on an inner periphery of the armature (168).

5. The toe-in actuator (16) as claimed in claim 1, characterized in that an end face (212) of the armature (168) is split into end faces (212a, 212b) of the at least two armature parts (216, 218), and at least one armature part (218) has a mass higher than further armature parts, wherein this at least one armature part (218) forms an end stop (212a) on the end face (212) of the armature (168).

6. The toe-in actuator (16) as claimed in claim 1, characterized in that the at least one damping element (220, 220a, 220b, 220c, 220d) is provided as an axial damping element (220, 220a, 220b, 220c, 220d) between at least two contact surfaces (252, 252a, 252b) of the at least two armature parts (216, 218).

7. The toe-in actuator (16) as claimed in claim 1, characterized in that the at least one damping element (220, 220a, 220b, 220c, 220d) comprises a resilient damping material having a Shore hardness between 10 and 70.

8. The toe-in actuator (16) as claimed in claim 1, characterized in that end faces of the at least two armature parts (216, 218), in a part of the armature (168) pointing away from the armature return element (171), have axial projections (240a, 240b) that engage in one another.

9. The toe-in actuator (16) as claimed in claim 8, characterized in that at least one damping element (220a, 220b) is provided between the projections (240a, 240b) of the at least two armature parts (218, 216).

10. The toe-in actuator (16) as claimed in claim 3, characterized in that the at least one armature part (216) that has the mass smaller than the further armature parts (216, 218), is formed on an outer periphery of the armature (168).

11. The toe-in actuator (16) as claimed in claim 3, characterized in that the at least one armature part (216) that has the mass smaller than the further armature parts (216, 218), is formed within the armature (168) between an inner and an outer periphery of the armature (168).
